(19) United States
(12) Patent Application Publication
(10) Pub. No.: US 2010/0062191 A1
(43) Pub. Date: Mar. 11, 2010

(54) MATERIAL WEB FOR THE PRODUCTION OF A BELLOWS OF A TRANSITIONAL SECTION, PARTICULARLY BETWEEN TWO ARTICULATED VEHICLE PARTS

(76) Inventor: Claus-Ekkehard Koukal, Kassel (DE)

Correspondence Address: GIFFORD, KRASS, SPRINKLE,ANDERSON & CITKOWSKI, P.C, PO BOX 7021, TROY, MI, 48007-7021, US

(21) Appl. No.: 12/527,789

(22) PCT Filed: Feb. 9, 2008
(86) PCT No.: PCT/DE2008/000244

§ 371 Date: Nov. 12, 2009

(30) Foreign Application Priority Data
Feb. 20, 2007 (DE) 10 2007 008 276.4

(51) Int. Cl. B32B 1/00; B32B 9/00

(52) U.S. Cl. 428/12; 428/411.1

(57) ABSTRACT

The invention relates to a material web for the production of a bellows of a transitional section, particularly between two articulated vehicle parts, by means of an annular fabric (30).

The invention relates to a material web for manufacturing a bellows of a transitional section, in particular between two hinge-linked vehicle parts.

A web of material for a bellows is known from prior art according to the document EP 0 607 503 B1 for example. A fabric is thereby provided, an insert made from metal wires, which is also configured as a metal fabric for example, being provided on the fabric, a nonwoven in the form of a needle felt being disposed above this insert. The fabric is coated and the insert is connected to the coated fabric by a vulcanisation process. The nonwoven is laminated onto needle felt for example.

What matters is that a bellows made from such a web of material is vandalism-proof to a certain extent. The reason therefore is that a knife, which is used to cut the bellows, hits this metal insert, meaning the wires of a metal fabric for example, which it cannot readily severe; instead, the knife pulls the discrete threads in the cutting direction until a plurality of such type metal threads fit against each other, thus finally opposing sufficient resistance to prevent further cutting and destruction of the bellows.

In principle, a bellows made in this way is already sufficiently vandalism-proof, in particular in the event of vandalism using cutting tools. However, it has been found out that the metallic threads forming the insert break in particular in the region where they are strongly bent. This is not particularly tragic in itself since it is only this region of the bellows, of extreme bending, that is no longer protected against cutting. The probability is quite low that a person whose objective it is to destroy such a bellows indeed knows that in this precise region a knife placed thereon would not encounter a corresponding resistance.

On the other side, the public transportation services would like to provide a bellows that is configured vandalism-proof in the same way all over its surface, meaning also in the region of strong bending.

It is the object of the invention to provide a web of material for manufacturing a bellows that is vandalism-proof all over its surface when used for making a bellows, meaning that is also vandalism-proof in regions of strong bending.

In accordance with the invention, this object is achieved by the fact that the web of material comprises a ring fabric, in particular a metallic ring fabric. Such a metallic ring fabric is characterized by discrete metallic rings that are connected to each other in a fashion similar to chain mail shirts used for personal security. Such an annular fabric is also used to manufacture gloves for persons working in meat processing facilities. As already explained, the discrete rings forming the fabric of such a ring fabric are joined together. Ring fabrics are also known in which the metallic rings are joined together by threads, such a ring fabric being known from DE 198 33 816 A1. All these ring fabrics have in common that they are extremely flexible whilst still offering sufficient protection against attacks with cutting tools. This means, the flexibility is achieved without the ring fabric deforming plastically in any way. Accordingly, a web of material for a bellows made in this way will not tear in the region of the bends, which means that such a bellows is vandalism-proof over the entire surface of a bellows made in this way.

Advantageous features and developed implementations will become apparent from the dependent claims.

In accordance with one feature of the invention, there is in particular provided that the ring fabric is embedded in an elastic plastic layer such as a silicone or an elastomer rubber. Surprisingly, it has been found out that by embedding the ring fabric into such an elastomer or silicone rubber the flexibility of the ring fabric as such will be hardly or not noticeably affected, meaning will not be affected in shape to such an extent as to no longer allow a web of material made in this way to serve as a web of material for manufacturing a bellows such as a pleated or corrugated bellows of a transitional section.

In accordance with a feature of the invention there is provided that the web of material comprises at least one textile layer, said ring fabric being connectable with this at least one textile layer. The connection between the textile layer and the ring fabric occurs in particular by sewing or stitching in such a manner that the flexibility of the web of material will not or not noticeably be affected in terms of its bending properties. In such a case, the textile layer, such as a knitted, a looped or a woven fabric, may also be coated on its outside with a plastic layer.

A particularly advantageous embodiment is characterized in that a textile layer is disposed on either side of the ring fabric, for example in the form of a knitted, a looped or a woven fabric, the two textile layers being connected together through the ring fabric such as by sewing or stitching, the connection also being such that the flexibility of a web of material made in this way is not affected. This means that the connection of the two textile layers through the ring fabric occurs with a certain clearance, that is to say that the ring fabric is only retained in its predetermined position between the two textile layers by sewing or stitching. In order to manufacture a such made web of material so as to be moisture-tight, at least one side of such a web of material is coated with a layer of plastic material. Advantageously, it has to be noted, with respect to the coating, that the textile layers only comprise this plastic layer on their outer top side.

Another object of the invention is also the bellows of a connection between two vehicles or vehicle parts that is characterized by one or more webs of material with a ring fabric of the type described herein above.

It is still a further object of the invention to use a ring fabric, in particular a metallic ring fabric, as an insert for a web of material for a bellows of a connection between two hinge-linked vehicle parts.

The invention will be discussed in closer detail herein after by way of example with reference to the drawings:

FIG. 1 schematically shows such a ring fabric;

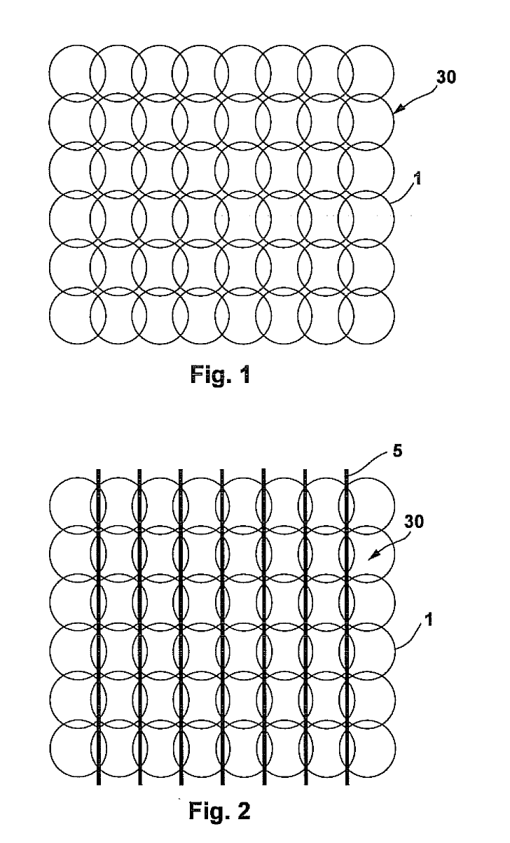

FIG. 2 shows a metallic ring fabric, the discrete metal rings being connected together by threads;

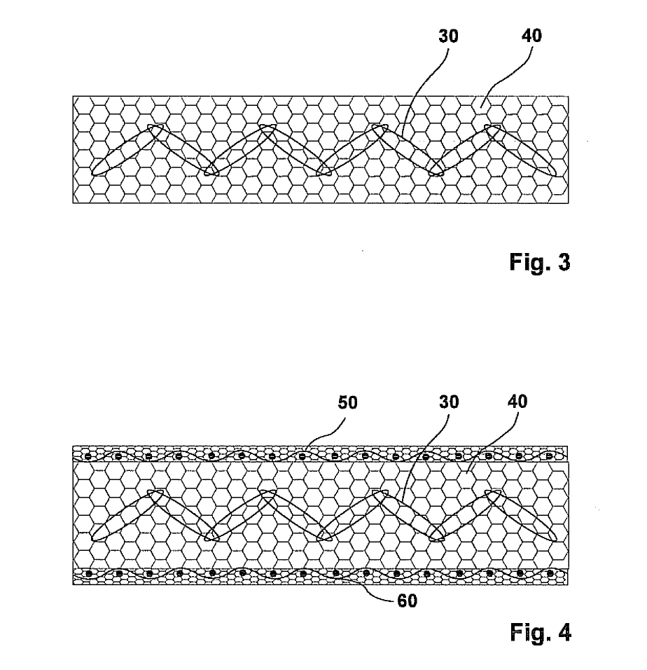

FIG. 3 shows a ring fabric, which is embedded in a plastic layer;

FIG. 4 schematically shows a ring fabric between two textile layers;

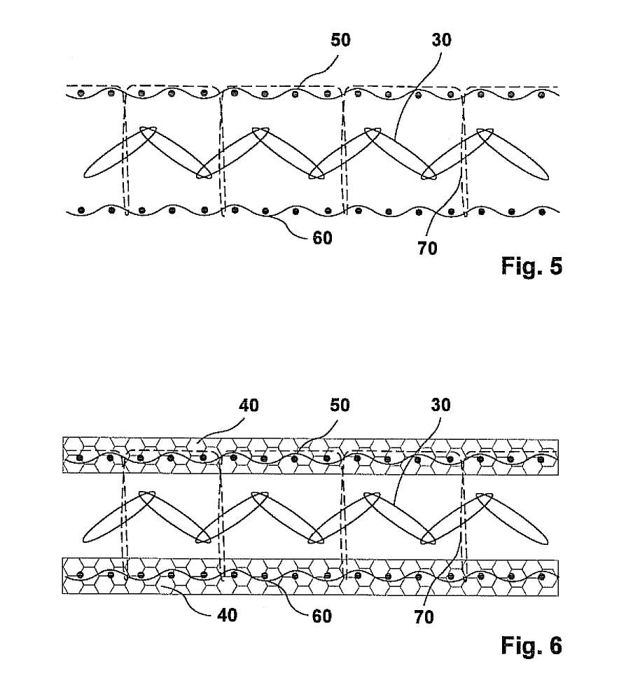

FIG. 5 shows an embodiment of a web of material as shown in FIG. 4, the two textile layers, between which the ring fabric is disposed, being joined together at a distance by threads;

FIG. 6 shows an embodiment as shown in FIG. 5, the textile layers comprising a plastic coating.

Referring to FIG. 1, the ring fabric 30 is characterized by discrete metallic rings 1, each ring being connected to its neighbouring ring. To connect the rings to each other, the openings of the rings are soldered together for example.

FIG. 2 shows another way of configuring such a ring fabric 30, the ring fabric shown therein being characterized in that the discrete rings 1 are joined together by threads 5.

FIG. 3 shows an embodiment in which such a ring fabric 30 is embedded in a plastic layer 40. The plastic layer can be an elastomer rubber or a silicone rubber.

FIG. 4 shows an embodiment in which the ring fabric 30 shown in FIG. 3, which is embedded into a plastic layer, is provided on either side with a textile layer 50 such as a knitted, a looped or a woven fabric. The textile layer may hereby be configured in one or more layers and also be embedded in a foamed layer. On the one side, such a textile layer has optical reasons but also serves to a considerable extent to increase the safety against destruction since the textile layers also ensure certain resistance against cutting.

In order to preserve the flexibility of such a web of material, there may be provided, in accordance with another embodiment, to connect the two textile layers 50, 60 by threads 70 passing through the ring fabric 30, such as by sewing, said threads 70 being spaced a certain distance apart, said distance corresponding approximately to the height of a compressed ring fabric, as is particularly obvious from FIG. 5. Such a web of material has a structure similar to that of a Mali fleece and it is provided that the textile layers 50, 60 comprise a plastic coating 40 in order to devise such a web of material to be liquid-tight in accordance with FIG. 6.

1. A bellows comprising a web of material disposed between two hinge-linked vehicle parts, wherein said web is comprised of a ring fabric.

2. A bellows as set forth in claim 1, wherein the ring fabric is a metallic ring fabric.

3. The bellows of claim 1, wherein the ring fabric is made from discrete rings which are connected together.

4. The bellows of claim 1, wherein the ring fabric comprises threads which are wound on the discrete rings.

5. The bellows of claim 1, wherein the ring fabric is embedded in an elastic plastic layer.

6. The bellows of claim 1, further including at least one textile layer, wherein the ring fabric is connectable with this at least one layer.

7. The bellows of claim 6, wherein the textile layer is embedded in a plastic layer.

8. The bellows of claim 6, wherein the at least one textile layer is connected to the ring fabric by sewing or stitching in such a way that the flexibility of the web of material is not affected in terms of bending properties.

9. The web of material of claim 6, wherein a plastic coating is applied to at least one side of the at least one textile layer.

10-11. (canceled)
